(19) United States
(12) Patent Application Publication
(10) Pub. No.: US 2010/0181288 A1
(43) Pub. Date: Jul. 22, 2010

(54) Method of fabrication of micro- and nanofilters

(75) Inventors: Cha-Mei Tang, Potomac, MD (US); Olga V. Makarova, Naperville, IL (US); Mark A. Hoffbauer, Los Alamos, NM (US); Todd L. Williamson, Los Alamos, NM (US); Platte T. Amstutz, Vienna, VA (US)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: CREATV MICROTECH, INC., Potomac, MD (US)

(21) Appl. No.: 12/691,407

(22) Filed: Jan. 21, 2010

Related U.S. Application Data
(60) Provisional application No. 61/146,157, filed on Jan. 21, 2009.

(51) Int. Cl. B44C 1/22

(52) U.S. Cl. 216/45; 216/41

(57) ABSTRACT

Micro- and nanofilters have a wide range of applications in many fields, including medical diagnostics, drug delivery, medical implants, and hemodialysis. Some issues that limit commercial application of current nanofilters in medicine are low pore density, non-uniform pore size, and the use of materials that are not biocompatible. A method is described to fabricate high porosity polymer and diamond micro- and nanofilters producing smooth, uniform and straight pores of high aspect ratio. Pore size, density, and shape can be predetermined with a high degree of precision by masks and controlled etch. The method combines energetic neutral atom beam lithography and a mask. This technology allows etching polymeric materials in a clean, well-controlled, and charge-free environment, making it very suitable for fabricating nanofilters and other components for biomedical applications.

### CROSS-REFERENCE TO RELATED APPLICATION

This application claims benefit from U.S. provisional application No. 61/146,157 filed on Jan. 21, 2009 the entire disclosure of which is incorporated herein by reference.

### FIELD OF THE INVENTION

The invention relates to methods of making micro- and nanopores in polymer films, diamond thin films, glassy carbon, and related materials by using (1) energetic neutral atoms to etch material through a mask physically integrated with the film to be patterned or a reusable mask applied to the surface of the film, or (2) reactive ion etching through a mask. The size and special distribution of the pores are predetermined by the mask and the etching method. The pores formed in the film are straight, uniform, and provide the film with high porosity. Energetic neutral atoms can fabricate pores with high aspect ratios.

### DESCRIPTION OF RELATED ART

Micro- and nanofilters are used for a wide range of applications. Filters with pores smaller than a few hundred microns (μm) are commonly used for biological assays. Filters can be used in biosensors, medical implants, dialysis, etc.

Most filters currently fall into the following categories: fibers, porous cellulose materials, nuclear track etched nanopores, and anodically oxidized alumina.

Fiber and cellulose based filters have non-uniform pore sizes. The material that passes through the fiber filter does not have either a narrow distribution in sizes or a sharp size cutoff and often becomes trapped in the filter.

Nuclear Track Etched Nanopores: In the early 1970s, nuclear track-etch processes were introduced that allowed fabrication of nanopore membranes with pores that are straight and uniform in size. These track-etched membranes are typically made in a polycarbonate or other plastic membranes. Plastic membranes exposed to a high-energy heavy ion beam, followed by a wet etching process create approximately cylindrical pores along the tracks left by the nuclear ions passing through the membrane. The pore size can be controlled by the etching time and other conditions. Such membranes are commercially available with pore sizes from about 10 nm to 30 with porosity 1-20% (www.it4ip.be). The overall number of pores per unit area is controlled by the exposure dose. However, excessively high exposure doses results in interconnected (overlapping) pores, compromising the pore uniformity.

Anodically Oxidized Alumina: Anodically oxidized alumina (AOA) membranes have a much higher porosity (up to 50%) than track-etched materials. Although these membranes have higher pore density (typically of >10⁹ pores/cm²), only a limited selection of pore sizes (20, 100 and 200 nm) are commercially available. For filtration applications, it is difficult to control pore configuration and arrangement for AOA membranes. In addition, it is also desirable to modify the surface properties of AOA membranes, as they are generally not either biocompatible or suitable for applications involving interactions with biomolecules, such as in protein separation devices, cell adsorption/growth, biosensing, and drug delivery. To improve the separation properties of anodically oxidized alumina membranes, it is desirable to reduce the average diameter of the pores, while retaining a narrow pore size distribution. It is also important to modify their surface properties. Nevertheless, these membranes are frequently used for many other applications including cell culture, biosensors, bioreactors, drug delivery and nanofabrication.

Reactive ion etching (RIE). Advances of fabrication techniques, including both conventional microelectromechanical systems (MEMS) and other non-conventional techniques, allow one to have better control over nanopore system geometry and to arrange multiple nanopores and nanofilters in an optimized manner to gain unique functionalities. MEMS fabrication allows seamless integration of molecular sieving systems with other microfluidic channels, which is non-trivial for conventional, sheet-style gels and membranes. RIE can be used to form pores in polymers and diamond films. When high-aspect-ratio (deep) pore dimensions are needed, charging of the material in the RIE processing environment can result in distortion of the pore shape and dimensions.

Examples of Conventional Method for Fabrication of Microfilters. Microfilters with precision pore size made of clear polymers deposited on a substrate has been described in Siyang Zheng, Henry Lin, Jing-Quan Liu, Marija Balic, Ram Datar, Richard J. Cote, Yu-Chong Tai. 2007. See “Membrane microfilter device for selective capture, electrolysis and genomic analysis of human circulating tumor cells”, J. Chromatography A. 1162, 154-161. The pore shapes were patterned by an UV lithography method. The holes were produced by reactive ion etching.

Regular pore structures have been achieved using thin silicon nitride (100 nm to several 1 μm thick) with excellent thermal stability and chemical inertness, high porosities and uniform pore sizes from several micrometers down to 50 nm. Their fabrication utilizes electron beam lithography, followed by RIE or FIB (Fast Ion Bombardment) etching to create pores in the SiN membrane. These filters can have a high throughput flux than track-etched or other membranes with the same cut-off pore size. However, these silicon membranes are prepared using a highly sophisticated and expensive approach, and it is difficult to etch pores with high aspect ratios. Interestingly, irrespective of regular pore geometry, blocking of pores by proteins or cell debris is still a major problem. Therefore, surface modification of membranes with tailored functional polymer layers may be essential for certain applications.

Potential Implant Applications of Diamond Nanofilters. The challenge for nanoporous membranes for biosensor and drug delivery implant applications are to develop materials that minimize cell adhesion, protein deposits, and encapsulation, since these biological reactions reduce the ability of active medical implant devices to function in the biological environment. These devices must exhibit functional stability over the months, years, and possibly decades. In a recent study, Narayan R J, Jin C, Menegazzo N, Mizaikoff B, Gerhardt RA, et al, “Nanoporous hard carbon membranes for medical applications”, J Nanosci tyanotech 2007, 7:1486-2493, demonstrated that diamond-like carbon (DLC) coated on nanoporous alumina membranes remained free from fibrin or platelet aggregation after exposure to human platelet rich plasma. The difficulty associated with this coating method is that the coating must cover the entire exposed surface. This may be difficult for high aspect-ratio pores. High aspect ratio pores may be necessary to obtain structural strength, Diamond films are an ideal material for such purposes, yet nanopores in diamond thin films have not yet been demonstrated.

### SUMMARY OF THE INVENTION

The invention describes methods to pattern and etch predetermined pore sizes, distributions and shapes in polymers, diamond thin films, glassy carbon, and other all-carbon materials.

The invention is directed to methods of forming filter elements having micro- or nanopores. The filter elements obtained according to the method of the invention can have aspect-ratio of about 200 with circular or non-circular pores with pore diameters of about 1 nm to >1 mm. Circular pores can provide a porosity of up to 90%. Non-circular pores provide a porosity greater than 90%.

An exemplary embodiment of this invention utilizes energetic neutral atom beams of oxygen and nitrogen. A method of generating energetic neutral atoms and etching is based on Energetic Neutral Atom Beam Lithography & Epitaxy (ENABLE). Principle of ENABLE is described in E. A. Akhadov, D. E. Read, A. H. Mueller, J. Murray, and M. A. Hoffbauer, J. Vac. Sci. Technol. B 23 (6), 3116-3119 (2005) and in Mark Hoffbauer and Elshan Akhadov, “Charge-free Method of forming nanostructures on a substrate”, U.S. Patent Application 2007/0114207 published on May 24, 2007 which is hereby incorporated by reference in its entirety. ENABLE uses neutral oxygen or nitrogen atoms to etch polymers and all carbon materials but this patent application does not disclose the formation of micro- and nanopores. The ENABLE technology allows for etching of polymeric and carbon materials at low temperature in a clean, well-controlled, and charge-free environment, making it very suitable for fabricating micro- and nanofilters and other components for biomedical applications.

Another exemplary embodiment of this invention describes methods to form a mask on diamond thin films that allows the formation of pores either by reactive ion etching or energetic neutral atom etching.

Another exemplary embodiment of this invention describes methods to make reusable masks for fabrication of micro- and nanofilters where the mask can be applied to and removed after formation of the micro- or nanofilter.

Another exemplary embodiment of this invention describes methods to etch pores simultaneously in multiple filter membranes.

Another exemplary embodiment of this invention describes methods to reduce pore dimensions of a mask and the effective pore diameter of the mask and filters.

Another exemplary embodiment of this invention describes methods to form pores in diamond thin films.

Exemplary embodiments of this invention also describe some applications of the polymeric and diamond filters.

### BRIEF DESCRIPTION OF THE DRAWINGS

FIG. 1A is a schematic diagram of the etching process involving the interaction of energetic neutral atoms with filter membrane.

FIG. 1B shows the etching process of FIG. 1A where the etching of the filter membrane has stopped at the substrate.

FIG. 2A is a schematic diagram showing pores in a filter membrane that the pores are substantially perpendicular to the filter membrane surface.

FIG. 2B is a schematic diagram showing pores in a filter membrane that the pores are at an inclined angle to the filter membrane surface.

FIG. 3A is a schematic diagram showing a filter membrane with a support to provide structural strength. The support material is the same as the filter membrane.

FIG. 3B is a schematic diagram showing a support material that is different from the filter membrane.

FIG. 4 is a schematic diagram showing the filter membrane with pores supported by a fiber backing material.

FIG. 5 is a schematic diagram of a process for forming pores using a free-standing reusable mask, where the mask is made by ENABLE and coated with a thin layer of metal.

FIG. 6 is a schematic diagram of a process for forming pores using a free standing reusable mask consisting of a thin metal film with pores.

FIG. 7 is a schematic diagram of a process for forming pores using anodically oxidized alumina as a free standing reusable mask.

FIG. 8 is a schematic diagram of a process for forming pores using anodically oxidized alumina formed on the filter membrane.

FIG. 9A is a schematic diagram of a process using a voltage provided by a power supply to immobilize an assembly that consists of a metal-coated mask, a filter membrane, and a conducting substrate for etching.

FIG. 9B is a schematic diagram of a process using a voltage provided by a power supply to immobilize the metallic metal coated mask and a conducting diamond thin film for etching.

FIG. 10A shows a plurality of layers of filter membranes etched simultaneously using one mask and where the filter membranes are of the same material.

FIG. 10B shows that several different filter membranes can be etched at the same time.

FIG. 11A shows a method to reduce the pore diameter of the mask by the use of directional vapor deposition of a layer of metal, silicon dioxide, or other suitable material.

FIG. 11B shows a method to reduce the pore diameter of the mask by conformal deposition of a layer of metal, silicon dioxide, or other suitable material.

FIG. 12 is a schematic diagram of a nanofilter with functionalized surfaces.

FIG. 13 is an SEM image of a polyimide film nanofilter with 200 nm pores and 400 nm periodicity.

FIG. 14 is a cross-sectional SEM image of the polyimide film nanofilter, where a focused ion beam was used to cut the filter at the 90° cross section.

### DETAILED DESCRIPTION OF EXEMPLARY EMBODIMENTS

The present invention is directed to methods of forming micro- or nanopores in a substrate and to a method of forming a filter. Exemplary embodiments of the invention are particularly directed to methods of producing micro- and nanofilters by ENABLE.

The micro- and nonporous filters are produced by applying a mask on a filter membrane where the mask has a plurality of pores corresponding to the desired size and location of the pores in the resulting filter member. The mask is placed on or above the membrane and a beam of energetic neutral atoms is directed onto the mask to etch the filter membrane and form the pores in the filter membrane and form the resulting filter. The mask is subsequently removed from the filter.

The mask for forming the pores in the filter membrane can be formed directly on the substrate as a continuous layer. The continuous layer can then be etched to form pores in the mask corresponding to the pores of the resulting filter. After the pores are etched in the filter membrane, the mask can be removed using standard procedures.

In another exemplary embodiment of the invention, a separate and reusable mask is formed and positioned over or on the filter membrane. The pores are then etched in the filter membrane. The mask can be lifted from the surface of the substrate and reused on another filter membrane. The mask in this embodiment can be formed from a metal film that is formed with a plurality of pores or holes that are oriented to correspond to the desired pores on the resulting substrate. The mask can be made from a metal that is not reactive to the etching process. The pores in the mask can be formed using standard mask forming procedures as known in the art. The mask can be a free-standing film or can be attached to a suitable support or frame to allow handling without damaging the mask.

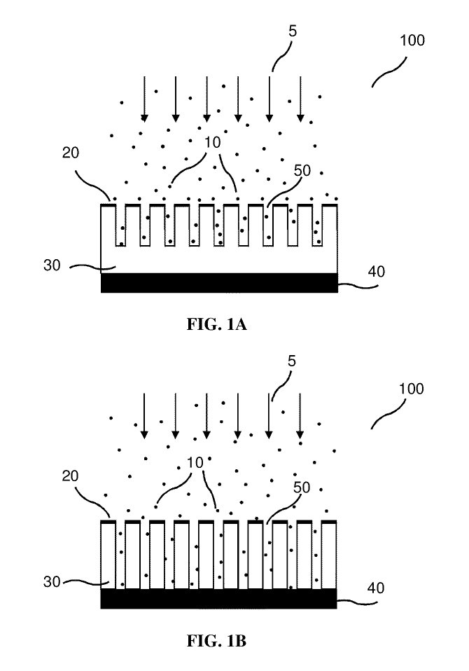

Principle of Energetic Neutral Atom Beam Lithography & Epitaxy (ENABLE): Polymer-based materials, glassy carbon, diamond thin films and other carbon based films or sheets 30, masked by a nonreactive material 20, can be etched using energetic neutral oxygen atoms with kinetic energies between 0.5 and 5 eV as shown in FIGS. 1A and 1B. Polymeric and diamond thin films can be fabricated directly on a supporting substrate 40. Alternatively, preformed filter membranes 30 can be attached to the substrate 40 by wax, shellac, glue and other laminating materials. Highly anisotropic (directional) etching occurs when energetic oxygen or nitrogen atoms 10 propagating in the direction of arrow 5 impinge upon the portions of the filter membrane 30, not covered by mask 20, to form volatile reaction products, which are removed by a vacuum system (not shown). The mask material 20 does not react with energetic oxygen or nitrogen atoms to form volatile products. When the sample is exposed to the incident collimated beam of energetic neutral atoms 10, the unprotected areas are anisotropically etched. Pores 50 are formed initially as shown in FIG. 1A and completed as shown in FIG. 1B.

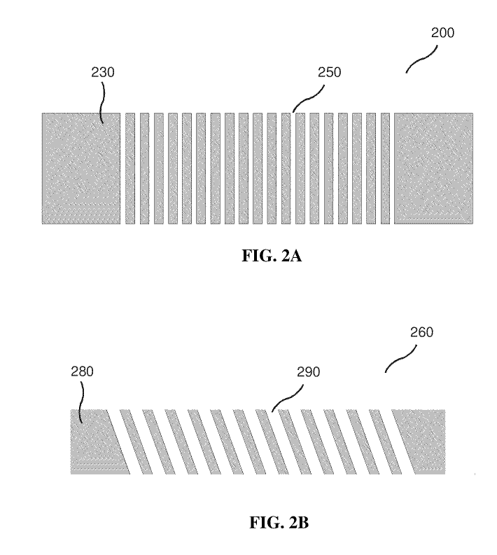

The filter membrane 30 with pores 50 can be removed from the supporting substrate 40 to form a micro- or nanofilter 200 as shown in FIG. 2A. The mask can be removed, if desired. The resulting micro- or nanofilter has a plurality of spaced-apart pores 250. In one embodiment, pores 250 in the resulting filter 200 are substantially straight, extending substantially perpendicular to the plane of filter 200. The pores can be uniform in size or different size, the same pattern as on the mask, The pores can be uniformly spaced-apart, or any other designed pattern as on the mask.

FIG. 2B shows another embodiment where the pores 290 are at an inclined angle with respect to the plane of the filter 260.

In one exemplary embodiment, the pores 250 in filter 200 have a substantially circular cross-section with an internal diameter of at least 5 nm and a porosity of up to 90%. In other embodiments, the pores having a circular cross-section can be greater than 5 nm. The pores can also be formed with a non-circular cross-section having a porosity of greater than 90%. The pores of the filter can have an aspect ratio of about 200.

By subjecting a confined volume of oxygen or nitrogen gas to a powerful laser, ENABLE creates a plasma, from which high-kinetic-energy neutral atoms can be extracted. The resulting collimated beam is then used to directly activate surface chemical reactions, forming the basis of a specialized tool for both etching at the nanoscale and growing thin films. The method allows the selective breaking of chemical bonds at relatively low temperatures in a clean, well-controlled, charge-free environment.

Due to the inherent properties of the oxygen atom beam (charge neutrality, directionality, and ˜98% atomic content) and the very direct chemistry involving the interaction of energetic oxygen atoms with polymer surfaces, reproduction of mask features into polymeric films or other filter membrane takes place without significant undercutting or tapering effects of the filter membrane that are characteristic of other polymer etching techniques.

Examples of suitable filter materials that can be etched include diamond thin films, glassy carbon, and polymers. Examples of polymers are polyimide, polyester, polycarbonate, polyethylene, perflourinated cyclobutane, polymethylmethacrylate (PMMA), various photoresists, parylene, and other polymers. Diamond thin films can be amorphous, nanocrystalline or ultrananocrystalline diamond. The diamond thin films can be electrically conducting or electrically insulating. In all cases, highly anisotropic etching is observed, with some variability in feature fidelity, due to specific polymer characteristics such as density, hardness, and other chemical and/or structural properties. For example, the mechanical stability of certain polymers limits the aspect ratios that can be reproducibly attained. In this disclosure, the term “filter membrane” will refer to any of the aforementioned materials that can be etched by RIE or ENABLE to make filters. The filter membrane can have any thickness to achieve aspect-ratio of thickness over diameter at least about 200.

ENABLE does not effectively etch polymers containing elements that react with energetic oxygen atoms to form nonvolatile compounds. For example, a polymer containing Si (such as polydimethyl-siloxane) would form a layer of SiO₂ that then effectively serves as an etch stop, limiting further erosion of the organic constituents in the polymer. Thus, SiO₂ can also be used as a mask for ENABLE etching.

The deBroglie wavelength of the energetic atoms is <0.1 nm, such that they behave in an essentially diffractionless fashion. Thus, there does not appear to be any physical limitation preventing ENABLE-based patterning or etching of features with characteristic sizes much larger than 0.1 nm, provided that a suitable mask is used.

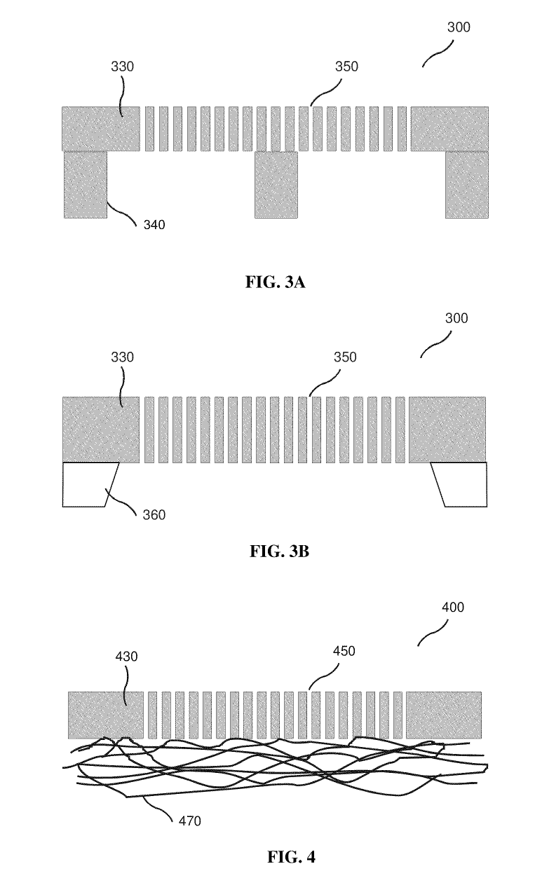

Micro- and Nanofilter Formats. ENABLE etching provides many fabrication options, for diverse applications. Micro- and nanofilters can be used in many formats. Three application format examples are described here. FIG. 2 shows straight pores 250 in filter membrane 230. FIG. 3A shows straight pores 350 in filter membrane 330 with a support 331 made of same material as filter membrane 330. FIG. 3B shows support 360 made of a different material than the filter membrane 330. FIG. 4 shows straight pores 450 in filter membrane 430 supported by fiber backing 470. There can be a wide range of formats and sizes to implement the micro- and nanofilters depending on the application.

Mask Materials. Typical metallic thin films, such as Cr, Al, Ni, Au/Pd, and other metals that have slow oxidation rate, can be used as a mask material. SiO₂ can also be used as mask for ENABLE and RIE.

Microfilter Mask Lithography. For pore sizes larger than 1 micron, patterning of the mask directly on the surface of the membrane can be achieved by UV lithography, electron beam lithography, nano-imprinting, or x-ray lithography.

Nanofilter Mask Lithography. For smaller pore sizes (˜<1 micron), the patterning of the mask directly on the surface of the filter membrane can be achieved by electron beam lithography, nano-imprinting or by other specialized lithography equipment.

Single Use Mask. Masks can be fabricated for each membrane to be fabricated by forming the mask directly on the surface of the filter membrane, such as mask 20 shown in FIGS. 1A and 1B. A mask must be made for each membrane to be etched. The mask is removed before the use of the resulting micro- and nanofilters.

Separable and Reusable Masks. For ENABLE etching the mask is not required to be attached to the surface of the filter membrane. If the mask is not attached to the filter membrane, it can be used multiple times to make multiple micro or nanofilters.

Fabrication using reusable masks is desirable, because a reusable mask can significantly reduce the cost of fabrication, especially the cost of electron beam lithography. This can be accomplished using separable masks for ENABLE. The feasibility of separable mask is based on the small deBroglie wavelength that allows a small gap between the mask and the filter membrane. The principle was tested using a wire mesh placed over a polymer membrane. The effect of the gap distance between the mask and the filter membrane on the resolution is as follows; gap distance of 10 μm resulted in a 5.4 nm degradation in minimum feature size, and gap distance of 0.1 mm resulted in a degradation of 17 nm in minimum feature size. The projected loss of minimum feature resolution for gap of 1 mm is projected to be about 55 nm. For microfilters, where the pore diameter is in thousands of nanometers, a gap distance as large as a few mm would still be tolerable for many applications.

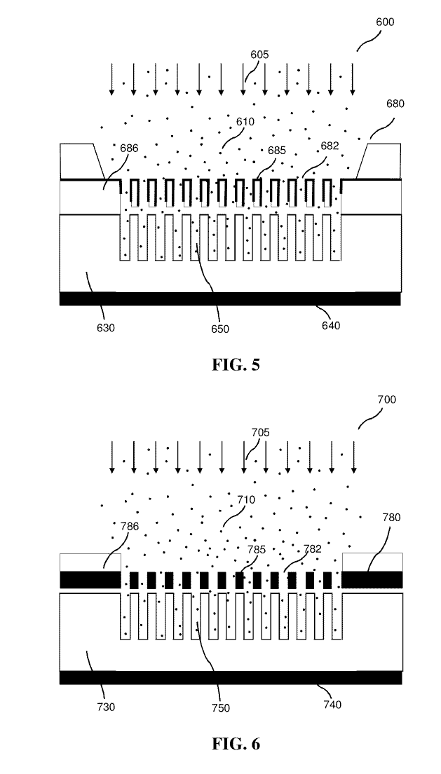

FIG. 5 shows a schematic diagram 600 of a method of forming pores in the filter membrane 630 by the neutral atoms 610 propagating in the direction of arrow 605. A separable or reusable mask assembly 680 is placed above the filter membrane 630 in the ENABLE etching method. The mask assembly 680 has pores 682 formed in a thin masking layer 685 coating on the surface of the mask form 686. The material for the mask layer 685 can be one or more of the following materials: Cr, Al, Ni, Au/Pd, other metals, or SiO₂. The mask assembly 680 allows the neutral atoms 610 to etch pores 650 in the filter membrane 630 mounted on a supporting substrate 640. The supporting substrate 640 is removed after forming the pores 650 all the way through the filter membrane 630 to the substrate 640. As shown in FIG. 5, the portion of the bottom surface of mask 686 can be recessed with respect to the outer edges to define a gap between the bottom surface of mask 686 and the top surface of membrane 630.

In another exemplary embodiment of an ENABLE etching method, FIG. 6 shows a schematic diagram 700 using a separable or reusable mask assembly 780 with pores 782 formed in a mask 785. The entire separable mask assembly 780 is made from one or more of the following materials: Cr, Al, Ni, Au/Pd, other metals, or SiO₂. The mask 780 is a thin membrane supported by a frame 786. In this embodiment, frame 786 defines a support and is attached to a top surface of mask 780. The energetic neutral atoms 710 are directed in the direction of arrow 705 to etch pores 750 in the membrane 730 mounted on a support substrate 740. The substrate 740 is removed after forming pores 750 all the way through the filter membrane 730 to the substrate 740. As shown in FIG. 6, membrane 780 is spaced from membrane 730 to define a gap there between. In one embodiment the gap is less than 0.1 mm for producing nanopores in the filter membrane.

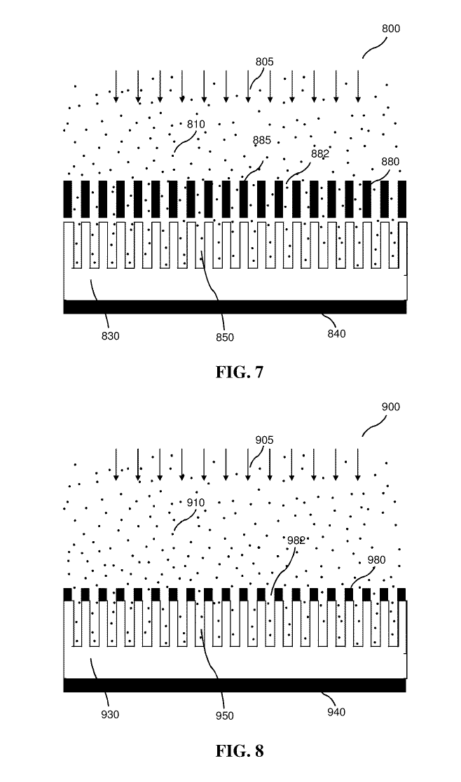

FIG. 7 shows a schematic diagram 800 of another exemplary embodiment of an ENABLE etching method using separable and reusable anodically oxidized alumina mask 880 with vertical pores 882 on a filter membrane 830. The energetic neutral atoms 810 are directed downwardly in the direction of arrows 805 to the top surface 885 of mask 880 to etch pores 850 in the filter membrane 830 mounted on a substrate 840. The substrate 840 is removed after forming the pores 850 all the way through the filter membrane 830 to the substrate 840.

FIG. 8 shows a schematic diagram 900 in another exemplary embodiment of an ENABLE etching method, where the anodically oxidized alumina mask 980 having pores 982 is formed directly on a polymer filter membrane 930. The energetic neutral atoms 910 are directed downwardly in the direction of arrows 905 to etch pores 950 in the polymeric filter membrane 930 mounted on a support substrate 940. The substrate 940 is removed after forming the pores 950 all the way through the filter membrane 930 to the substrate 940. The anodically oxidized alumina mask 980 can be removed, if desired.

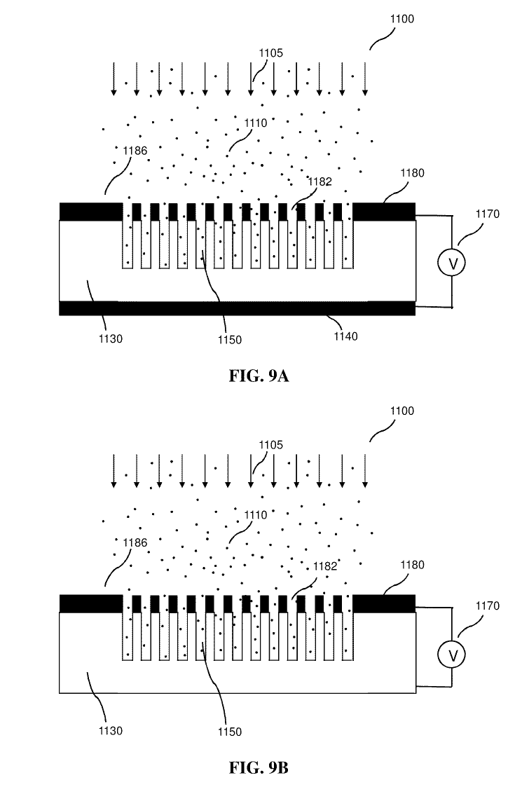

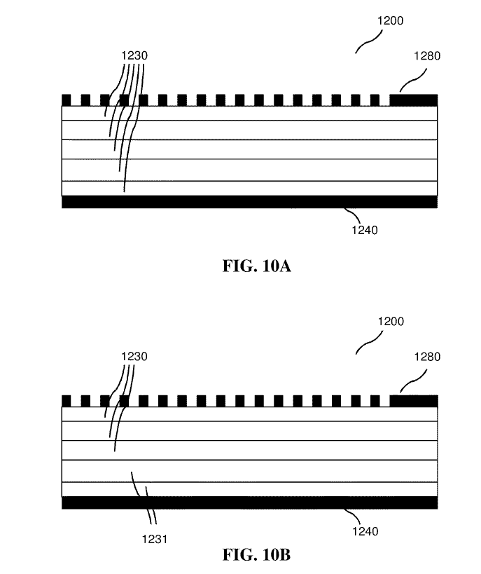

In still another exemplary embodiment of ENABLE etching using an electrically conducting separable mask 1180 and a filter membrane 1130 to be etched are placed in close proximity and fixed in place during the etching process via an electrostatic assembly as shown in FIG. 9A. The filter membrane 1130, which can be a polymer or non-conducting diamond, is mounted on an electrically conducting substrate 1140. FIG. 9A shows a schematic diagram 1100 using the separable electrically conducting mask 1180, consisting of an electrically conducting material with pores 1182. The conducting substrate can be metal, graphite, metal coated graphite, metal coated silicon wafer, etc. The filter membrane 1130 is fixed between the electrically conducting mask 1180 and the electrically conducting substrate 1140 and electrostatically held together by applying a voltage V by a power supply 1170 connected between mask 1180 and substrate 1140. The energetic neutral atoms 1110 are directed in the direction of arrow 1105 to etch pores 1150 in the filter membrane 1130. The mask 1180 and the substrate 1140 are removed after forming the pores 1150 in the filter membrane 1130.

In one exemplary embodiment, the filter membrane 1130 can be separate from the substrate 1140 or attached to the substrate 1140 before applying the voltage V by power supply 1170. Polymeric and diamond thins can fabricated directly on the substrate 1140. Preformed filter membrane 1130 can be attached to the substrate 1140 by wax, shellac, glue or other laminating materials.

In a further exemplary embodiment, the filter membrane to be etched is an electrically conducting diamond thin film, where the electrically conducting diamond thin film can be attached to a substrate, although this attachment is not required. The substrate in this embodiment need not be electrically conducting. The terminals of the power supply 1170 as shown in FIG. 9B are connected to the electrically conducting mask 1180 and the electrically conducting diamond thin film 1130.

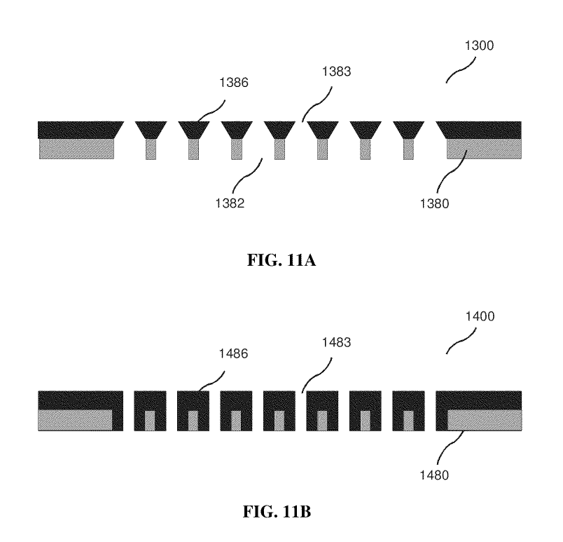

FIG. 10A shows one exemplary embodiment where more than one layer of the filter membrane 1230 are in stacked relationship with a single mask 880 applied to uppermost filter membrane 1230. All of the stacked filter membranes 1230 are etched by the same mask in a single etching process. The etching time will increase as the total or combined thickness of the films increases. The filter membrane can be the same material as in FIG. 10A or different materials as in FIG. 10B. The stack of filter membranes is applicable to both RIE and ENABLE etching. The stack can be physically attached together by wax, shellac, glue or other etchable laminating materials. The stack can also be immobilized together by electrostatic forces.

It is difficult to make masks with a pore sizes much smaller than 50 nm by electron beam lithography. FIG. 11A depicts a modified mask 1300 having an effective pore diameter that is less than that obtainable by conventional mask-forming methods. FIG. 11A shows that the dimension of pores 1382 of the original mask 1380 can be reduced by directional deposition of a layer of metal, silicon dioxide, or other suitable material 1386 on top of the mask 1380. The deposited layer 1386 is deposited on the mask 1380 to form pores 1383 in layer 1386 that have a diameter less than the diameter of pores 1382 of the mask 1380. The layer 1386 defines the modified mask 1300.

FIG. 11B shows that the pore dimensions of an original mask 1480 can also be reduced by conformal deposition of a layer of metal, silicon dioxide, or other suitable material 1486 around the inner surface of the pores of the mask to reduce the diameter of the pores to form a modified mask 1400. The deposited layer 1486 is formed with pores 1483 having a diameter less than the diameter of the mask 1480. The smaller pore size in the mask will result in smaller pores etched in filter membrane.

A method used to make a metal mask on polymer film includes the following steps: (1) spin on a negative photoresist; (2) cover the photoresist with a thin electrically conductive polymer; (3) pattern the pores by electron beam lithography; (4) develop the resist to obtain pillars; (5) deposit a layer of Cr, Ni, Al or another metal; (6) lift-off the pillars to obtain the pores of the mask. A detailed description can be found in the paper by Olga V. Makarova, Cha-Mei Tang, Platte Amstutz, Ralu Divan, Alexandra Imre, Derrick C. Mancini, Mark Hoffbauer, Todd Williamson, “Fabrication of high density, high-aspect-ratio polyimide nanofilters”, JVST B, 27, 2585-2587 (2009).

To form a metal mask on diamond film, the fabrication protocol requires a modification as described in the paper by Makarova 2009. Some metals, including Cr, Ni or Al by themselves, will not attach to the diamond film directly. A layer of W, Ti or other material compatible with diamond is needed to bond Cr, Ni or Al to the diamond film. Similar to polymers, a layer of SiO₂ can also be used as a mask. Following the formation of the mask, the diamond thin film can be etched by RIE or ENABLE.

The parameters of pores that can be fabricated depend on the filter membrane material properties, substrate and mask materials, the aspect-ratio (height over diameter of the pores), and the etching method and conditions. Under ideal conditions and available mask, the pore dimensions can have diameters greater than 1 nm and aspect-ratios of greater than 200 for ENABLE-based etching. For RIE, diameters are typically larger than 200 nm with aspect ratios typically less than 10. The geometry of the pores does not need to be circular. Porosity can be as high as 90% for circular pores and >90% for some other pore shapes. The limitation on the porosity attained is the structural strength of the filter membrane and the requirements of the particular application, and is not limited by ENABLE fabrication.

Surface Functionalization of Polymeric Nanofilters. It is important to have the desired surface properties of polymeric nanopore membranes, depending on the potential application. The surface conditions of the polymeric nanopore membranes ranging from wetting, reactivity, surface charge, and biocompatibility will determine the separation process and performance.

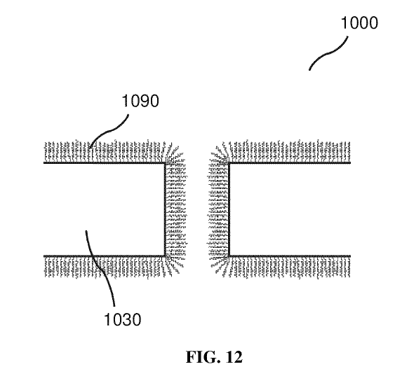

One surface modification technique of polymers involves plasma treatment of polymers to activate the surface and graft self-assembled monolayers with a range of functionality including amine, carboxyl, hydroxyl, epoxy, aldehyde, and polyethylene glycol (PEG) groups by using silane chemistry with solution immersion or vapor deposition. For example, grafting PEG-triethoxysilane onto an oxidized polymer renders the surfaces hydrophilic in a controlled manner. The surface 1090 of nanopores can be functionalized on the polymer 1030 as depicted in FIG. 12. Such treatments would provide opportunities for bioseparations.

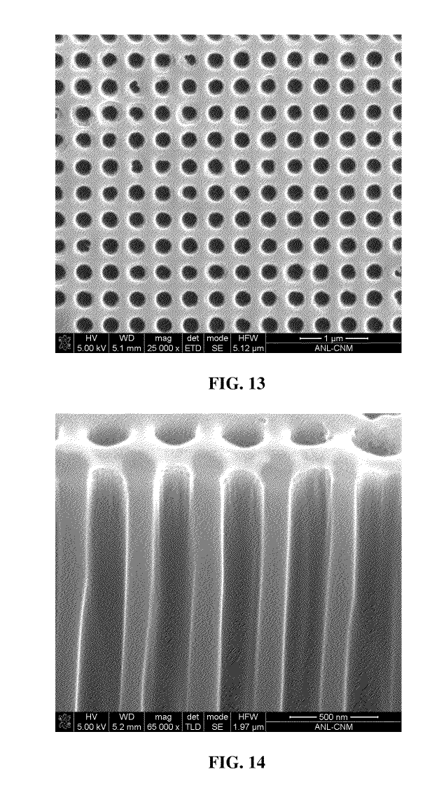

FIG. 13 shows a SEM image of a polyimide film nanofilter with 200 nm pores and 400 nm periodicity etched by ENABLE using ˜2.8 eV neutral oxygen atoms. The original 40 nm thick Cr layer used for ENABLE etching had been removed, so a new 2 nm thick Cr layer was deposited on the filter to allow SEM imaging without charging. The hole diameter patterned by ENABLE is about 200 nm, with 400 nm periodicity. The holes have vertical walls about 10 μm deep, with an undercut of about 50 nm.

FIG. 14 is a cross-sectional view showing that the holes have vertical walls. The cross sectional cut in the front row were made visible by focused ion-beam milling. Aspect ratios of ˜40 have been achieved for FIG. 14.

While the invention has been shown and described with reference to certain exemplary embodiments thereof, it will be understood by those skilled in the art that various changes in form and details may be made therein without departing from the spirit and scope of the invention, as defined by the appended claims and equivalent thereof.

We claim:

1. A method of producing micro- and nanofilters comprising the steps of:
providing a filter membrane having an outer surface;
providing a mask adjacent to the outer surface of the filter membrane, the mask having a plurality of spaced-apart holes with an internal diameter;
directing an etching beam onto the mask and through the holes in the mask for a time sufficient to form a plurality of pores in the filter membrane.

2. The method of claim 1, wherein said etching beam comprises a beam of energetic neutral atoms of oxygen or nitrogen.

3. The method of claim 1, wherein said etching beam comprises reactive ions.

4. The method of claim 1, wherein
the pores formed in the filter membrane have a diameter corresponding substantially to the diameter of the holes in the mask.

5. The method of claim 2, wherein the mask is separable from the filter membrane and is reusable.

6. The method of claim 3, wherein the mask is made of metal.

7. The method of claim 3, wherein the mask has a coating of a thin metallic film.

8. The method of claim 7, wherein the thin metallic film is selected from the group consisting of Cr, Al, Ni, Au/Pd, W, and Ti.

9. The method of claim 1, where the mask is made of SiO₂.

10. The method of claim 4, wherein the mask is not attached directly to the filter membrane.

11. The method of claim 5, wherein the separable mask is spaced from a top surface of the filter membrane a distance less than 0.1 mm to produce nanopores.

12. The method of claim 1, wherein said filter membrane is a polymeric film and is selected from the group consisting of polyimide, polyester, polycarbonate, polyethylene, perflourinated cyclobutene, polymethylmethacrylate, photoresists, and parylene.

13. The method of claim 1, wherein the filter membrane is an amorphous nanocrystalline or ultrananocrystalline diamond film.

14. The method of claim 1, where the pores in the filter membrane have an aspect-ratio greater than 200.

15. The method of claim 1, wherein the filter membrane includes a support layer, and where the resulting micro- or nanofilter is removable from the support layer.

16. The method of claim 1, further comprising
providing a plurality of the filter membranes in a stack and etching a plurality of nanopores in each of the stacked filter membranes.

17. The method of claim 1, wherein the pores have a diameter of greater than 5 nm and circular pores with a porosity up to 75%.

18. The method of claim 1, wherein the pores have a diameter greater than 5 nm and non-circular pores with a porosity of greater than 90%.

19. The method of claim 1, further comprising
forming the mask directly on the surface of the filter membrane and thereafter forming said pores in said filter membrane.

20. The method of claim 2, wherein the filter membrane is electrically conductive and the mask is electrically conductive, said method further comprising
applying an electric voltage between the filter membrane and the mask to form an electrostatic attraction between them to secure the mask to the filter membrane.

21. The method of claim 2, wherein the filter membrane is supported on an electrically conductive support and where the mask is electrically conductive, said method further comprising
applying an electric voltage to the support and the mask to form an electrostatic attraction between them and to secure the mask to the filter membrane disposed between the mask and the support.

22. A method of producing micro- or nanofilters comprising the steps of:
providing a mask having a top surface and a plurality of spaced apart holes extending through said mask, said holes having a first internal diameter;
depositing a layer of a material on said top surface of said mask to form a layer attached to the mask, where in the holes in the layer have a second internal diameter less than said first internal diameter;
providing the mask on in outer surface of a filter membrane; and
directing an etching beam onto the mask for a time sufficient to form a plurality of pores in the filter membrane and produce said micro- or nanofilter.

23. The method of claim 22, wherein said mask is photoresist, polymer or diamond filter and said layer is a metal or silicon dioxide.

24. The method of claim 22, wherein said layer is applied only to said top surface of said mask.

25. The method of claim 22, wherein said layer is applied to said top surface and to inner surfaces of said pores in said mask.

26. A method of producing micro- or nanofilters comprising the steps of
forming a mask having a plurality of spaced-apart holes;
positioning said mask above a top surface of a membrane filter; and
directing an energetic neutral atom beam onto said mask to form a micro- or nanofilter having a plurality of pores corresponding substantially to the dimensions of the holes in the mask.

27. The method of claim 26, wherein said mask is independent from the filter membrane and separable from said filter membrane.

28. The method of claim 27, wherein said mask has a support structure coupled to said mask.

29. The method of claim 28, further comprising positioning said mask in direct contact with said filter membrane.

30. The method of claim 28, further comprising spacing said mask from said top surface of said filter membrane to define a gap therebetween.
